(19) United States
(12) Patent Application Publication
(10) Pub. No.: US 2020/0298214 A1
(43) Pub. Date: Sep. 24, 2020

(54) PHOTOCATALYTIC WATER SPLITTING WITH COBALT OXIDE-TITANIUM DIOXIDE-PALLADIUM NANO-COMPOSITE CATALYSTS

(71) Applicant: SABIC GLOBAL TECHNOLOGIES B.V., Bergen op Zoom (NL)

(72) Inventors: Mohd Adnan KHAN, Thuwal (SA); Maher AL-OUFI, Thuwal (SA); Hicham IDRISS, Thuwal (SA)

(73) Assignee: SABIC Global Technologies B.V., Bergen op Zoom (NL)

(21) Appl. No.: 15/779,700

(22) PCT Filed: Dec. 2, 2016
(86) PCT No.: PCT/IB2016/057315

§ 371 Date: May 29, 2018

Related U.S. Application Data
(60) Provisional application No. 62/264,427, filed on Dec. 8, 2015.

(51) Int. Cl. B01J 23/89; B01J 21/06; C01B 3/04; C01B 13/02; B01J 35/00; B01J 35/02; B01J 19/12

(52) U.S. Cl. CPC B01J 23/8913; B01J 21/063; C01B 3/042; C01B 13/0207; B01J 35/004; B01J 35/0033; B01J 2219/1203; B01J 35/023; B01J 35/026; B01J 19/123; B01J 2219/0877; B01J 2219/0892; B01J 35/006

(57) ABSTRACT

Photocatalysts and methods of using the same for producing hydrogen and oxygen from water are disclosed. The photocatalysts include photoactive titanium dioxide loaded with 0.5 wt. % to 4 wt. % of a hole-scavenging material comprising cobalt oxide and 0.1 wt. % to 1 wt. % of palladium (Pd) and/or a Pd—Co alloy.

### CROSS REFERENCE TO RELATED APPLICATIONS

This application claims the benefit of priority of U.S. Provisional Patent Application No. 62/264,427, filed Dec. 8, 2015, which is hereby incorporated by reference in its entirety.

### BACKGROUND OF THE INVENTION

### A. Field of the Invention

The invention generally concerns a composite photoactive catalyst that can be used to catalyze a water-splitting reaction and produce hydrogen and oxygen from water. The catalyst includes photoactive titanium dioxide loaded with 0.5 wt. % to 4 wt. % of a hole-scavenging material comprising cobalt oxide and 0.1 wt. % to 1 wt. % of palladium (Pd) and/or a Pd-Cobalt (Co) alloy.

### B. Description of Related Art

Hydrogen production from water offers enormous potential benefits for the energy sector, the environment, and the chemical industry (See, for example, Kodama & Gokon, Chem. Rev., 2007, Vol. 107, p. 4048; Connelly & Idriss, Green Chemistry, 2012, Vol. 14, p. 260; Fujishima & Honda, Nature 238:37, 1972; Kudo & Miseki, Chem. Soc. Rev 38:253, 2009; Nadeem, et al., Int. J. Nanotechnology, 2012, Vol. 9, p. 121; Maeda, et al., Nature 2006, Vol. 440, p. 295). While methods currently exist for producing hydrogen from water, many of these methods can be costly, inefficient, or unstable.

With respect to photocatalytic electrolysis of water from light sources, while many advances have been achieved in this area, most materials are either unstable under realistic water splitting conditions or require considerable amounts of other components (e.g., large amounts of sacrificial hole or electron scavengers) to work, thereby offsetting any gained benefits. By way of example, a semiconductor photocatalyst is a material that can be excited upon receiving energy equal to or higher than its electronic band gap. Upon photo-excitation, electrons are transferred from the valence band (VB) to the conduction band (CB), resulting in the formation of an excited electron (in the CB) and a hole (in the VB). In the case of water splitting, electrons in the CB reduce hydrogen ions to H₂ and holes in the VB oxidize oxygen ions to O₂.

One of the main limitations of most photocatalysts is fast electron-hole recombination, a process that occurs at the nanosecond scale, while the oxidation-reduction reactions are much slower (microsecond time scale). Many approaches have been conducted in order to design a photocatalyst that can work under direct sun light in stable conditions. Problems associated with these types of systems include light absorption efficiency, charge carrier life time, and materials stability. In order to enhance light absorption, a large number of photocatalysts were designed based on visible light range band gap either by solid solutions, hybrid materials, or doping of wide band gap semiconductors. In order to increase the charge carrier's life time, hydride semiconductors, addition of metal nanoparticles, and the use of sacrificial agents are currently used (See, for example, Connelly et al, Green Chemistry, 2012, Vol. 14, pp. 260-280; Nadeem et al., Int. J. Nanotechnology, Special edition on Nanotechnology in Scotland, 2012, Vol. 9, pp. 121-162; Connelly et al., Materials for Renewable and Sustainable Energy, 2012, Vol. 1, pp. 1-12; Walter et al, Chem. Rev., 2010, Vol. 110, pp. 6446-6473; and Yang et al., Appl. Catal. B: Environmental, 2006, Vol. 67, pp. 217-222). Ultimately, however, over 90% of photo-excited electron-hole pairs disappear/recombine prior to performing the desired water splitting reaction, thereby making the currently available photocatalysts inefficient (See, for example, Yamada, et al., Appl Phys Lett., 2009, Vol. 95, pp. 121112-121112-3).

Various semiconductors such as TiO₂, CdS, ZnO, C₃N₄ and WO₃ have been explored for water splitting (see, e.g., Kudo and Miseki, “Heterogeneous photocatalyst materials for water splitting”, Chem. Soc. Rev. 2009, 38, 253-278). TiO₂ remains the leading semiconducting material for water splitting with its good conversion efficiency (of UV light: ca. 4-5% of the solar spectrum) and stability. Improving the light absorption and charge carrier separation in TiO₂ remains the biggest challenge for improving the efficiency of the water splitting process. Loading of co-catalysts such as metal nanoparticles or secondary semiconductors, acting as either electron or hole acceptors for improved charge separation, is a promising strategy. Various noble metals such as Pt, Au, and Ag have been studied with some depth with TiO₂ for their water splitting activity (see, e.g., Jovic et al., “Effect of gold loading and TiO2 support composition on the activity of Au/TiO2 photocatalysts for H₂ production from ethanol-water mixtures”, J. Catal. 2013, 305, 307-317). These metal particles act primarily as reduction co-catalysts/electron sinks, therefore acting to limit electron-hole recombination and improving the H₂ production rates.

Cobalt oxide has also been used in conjunction with TiO₂ for photocatalytic water splitting (see, e.g., Sadanandam et al., “Cobalt doped TiO2: A stable and efficient photocatalyst for continuous hydrogen production from glycerol:Water mixtures under solar light irradiation”, Int. J. Hydrogen. Energ. 2013, 38, 9655-9664). Some stability issues were observed in Sadanandam et al., as catalytic activity under UV light decreased with time due to leaching of Co metal ions into the solution.

While incremental increases in photoactive efficiency have been observed, the current photocatalysts remain largely inefficient or unstable for large-scale commercial use.

### SUMMARY OF THE INVENTION

A solution to the aforementioned inefficiencies surrounding current water-splitting photocatalysts has been discovered. The solution resides in the discovery of a combination of materials in specified amounts that maximizes photocatalytic splitting of water into hydrogen (H₂) and oxygen (O₂). In particular, it has been discovered that photoactive titanium dioxide loaded with 0.5 wt. % to 4 wt. % of a hole-scavenging material comprising cobalt oxide (preferably CoO) and 0.1 wt. % to 1 wt. % of palladium (Pd) can maximize hydrogen (H₂) and (O₂) production. In certain aspects, the 0.1 wt. % to 1 wt. % Pd can be a combination of separate Pd particles and Pd—Co alloy particles. As illustrated in non-limiting embodiments in the Examples and Figures, maximum H₂ production can be obtained in instances where 1.5 wt. % to 2.5 wt. % (and preferably about 2 wt. %) cobalt oxide and 0.2 wt. % to 0.4 wt. % (and preferably about 0.3 wt. %) Pd are loaded onto titanium dioxide. Without wishing to be bound by theory, it is believed that cobalt oxide in these amounts acts as a hole scavenger at the interface between the cobalt oxide and titanium dioxide, thereby increasing the likelihood that the electrons and holes produced in response to light absorption by titanium dioxide can participate in the oxidation/reduction reaction of water rather than recombining with one another. Stated another way, the presence of cobalt oxide in these weight percentage ranges increases the charge carrier life time and reduces the likelihood of an electron-hole recombination event from occurring. Still further, the use of Pd in the discovered weight percentage range further increases the catalytic activity of the titanium dioxide-cobalt oxide composite by a factor of about 4, thereby maximizing H₂ and/or O₂ production. The end result is a composite titanium dioxide-based catalyst that is doped with cobalt oxide and palladium in defined or critical ranges that produces maximal catalytic activity. Non-limiting data confirms that the water-splitting catalysts of the present invention have sufficient stability, as no catalytic deactivation was observed for prolonged reaction times (e.g., up to about 24 hours). Therefore, the catalysts of the present invention can meet the efficiency and stability requirements desired for large-scale commercial use in the production of H₂ and O₂ from the photocatalytic water-splitting reaction.

In one aspect of the present invention there is disclosed a water-splitting photocatalyst comprising photoactive titanium dioxide loaded with 0.5 wt. % to 4 wt. % of a hole-scavenging material comprising cobalt oxide and 0.1 wt. % to 1 wt. % of palladium (Pd) or 0.1 wt. % to 1 wt. % Pd and Pd—Co alloy. That is, the Pd can be in the form of Pd, a Pd—Co alloy, or a combination of Pd and Pd—Co alloy. In preferred embodiments, the water-splitting photocatalyst includes 1.5 wt. % to 2.5 wt. % cobalt oxide and 0.2 wt. % to 0.4 wt. % Pd, or more preferably about 2 wt. % cobalt oxide and about 0.3 wt. % Pd and/or Pd—Co alloy. The cobalt oxide can be cobalt (II) oxide (CoO), cobalt (III) oxide (Co₂O₃), or cobalt (II,III) oxide (CO₃O₄), preferably cobalt (II) oxide. The cobalt oxide can be in amorphous form such that it has no diffraction line or is highly dispersed cobalt (II) oxide. The titanium dioxide can be anatase, rutile, or brookite, or any combination thereof. In some aspects, it is single phase anatase. In other aspects, it is a mixed-phase comprising anatase and rutile. The ratio of anatase to rutile can be 1.5:1 to 10:1. Still further, the photoactive titanium dioxide, the hole-scavenging material, and the Pd can each be in particulate form. The photocatalyst can be a heterogeneous catalyst when placed into the aqueous composition. The photoactive titanium dioxide, the hole-scavenging material, and the Pd can each be nanostructures, non-limiting examples of which include nanowires, nanoparticles, nanoclusters, or nanocrystals, or combinations thereof. The hole-scavenging material can be deposited on the surface of the photoactive titanium dioxide. In preferred aspects, the hole-scavenging material is evenly dispersed on the titanium dioxide. The Pd metal can be deposited on the surface of the photoactive titanium dioxide or the surface of the hole-scavenging material, or on both surfaces.

Also disclosed in the context of the present invention is an aqueous composition comprising any one of the water-splitting photocatalysts of the present invention. The photocatalyst can be dispersed and not solubilized in the aqueous composition. The aqueous composition can have a pH of 7 to 13, preferably a pH of 9 to 10. The aqueous composition can include 1 w/v % to 10 w/v % of a sacrificial agent that is partially or fully solubilized in the aqueous composition. In other instances, less than 1 w/v % or no sacrificial agent is present in the aqueous composition. Non-limiting examples of sacrificial agents include methanol, ethanol, propanol, butanol, iso-butanol, methyl tert-butyl ether, ethylene glycol, propylene glycol, glycerol, or oxalic acid, or any combination thereof. In preferred instances, the sacrificial agent can be ethylene glycol or glycerol or a combination thereof. The aqueous composition can include 0.1 to 2 g/L of the photocatalyst.

In still another aspects of the present invention, there is disclosed an aqueous composition comprising a water-splitting photocatalyst having photoactive titanium dioxide loaded with 1.5 wt. % to 2.5 wt. % of a hole-scavenging material comprising cobalt oxide and a sacrificial agent solubilized in the aqueous composition, wherein the aqueous composition has a pH of 7 to 13. In preferred instances, the aqueous composition can have a pH of 9 to 10. The photocatalyst in this embodiment may not include Pd. Still further, the photocatalyst may not include a plasmonic metal (e.g., Ag or Au or alloys thereof).

In yet another embodiment of the present invention, there is disclosed a water-splitting system for generating hydrogen from water. The system can include a container/reaction vessel comprising water and any one of the photocatalysts or aqueous compositions of the present invention. In certain preferred embodiments, the photocatalyst can be suspended or dispersed in the aqueous composition, thereby creating a heterogeneous system. Alternatively, the catalyst can be coated onto the surface of the reaction vessel's walls such that the water-splitting reaction takes place at the interface between the water and the vessel's walls. In other instances, the photocatalyst can be included a reaction bed that is then immersed in the water/aqueous solution. The bed or plurality of beds (e.g., at least 2, 3, 4, 5, 6, 7, 8, 9, 10, or more) can be positioned or angled at determined locations to maximize the interaction of light with the catalysts and thus maximize the production of H₂ and O₂. A light source can be included in the system. The light source can be sunlight or an artificial light source, or a combination thereof. The artificial light source can be an ultraviolet lamp or a Xenon lamp.

In still another embodiment of the present invention, there is disclosed a method for producing oxygen (O₂) and hydrogen (H₂) from water, the method comprising obtaining the aqueous composition or systems of the present invention and subjecting the water having the photocatalyst to a light source for a sufficient period of time to produce O₂ and H₂ from the water. Non-limiting hydrogen production rates include 1.5×10⁻⁴ to 2.5×10⁻⁴ mol/g_{Catal} min when palladium is included in the photocatalyst and 1.5×10⁻⁵ to 2.5×10⁻⁵ mol/g_{Catal} min when palladium is not included in the photocatalyst. The reaction conditions can include sunlight or an ultraviolet light luminous flux of 3 to 7 mW/cm² and 30 mL of 5 vol % glycerol aqueous solution. The amount of sacrificial agent can be modified or tuned as desired. In some aspects, the aqueous composition is a 5 vol % glycerol aqueous solution. The ratio of H₂ to O₂ produced can be 8 to 50.

In the context of the present invention 54 embodiments are described. Embodiment 1 is a water-splitting photocatalyst comprising photoactive titanium dioxide loaded with 0.5 wt. % to 4 wt. % of a hole-scavenging material comprising cobalt oxide and 0.1 wt. % to 1 wt. % of palladium (Pd). Embodiment 2 is the water-splitting photocatalyst of embodiment 1, comprising 1.5 wt. % to 2.5 wt. % cobalt oxide and 0.2 wt. % to 0.4 wt. % Pd. Embodiment 3 is the water-splitting photocatalyst of embodiment 2, comprising about 2 wt. % cobalt oxide and about 0.3 wt. % Pd. Embodiment 4 is the water-splitting photocatalyst of any one of embodiments 1 to 3, wherein the cobalt oxide is cobalt (II) oxide, cobalt (III) oxide, or cobalt (II, III) oxide. Embodiment 5 is the water-splitting photocatalyst of embodiment 4, wherein the cobalt oxide is cobalt (II) oxide. Embodiment 6 is the water-splitting photocatalyst of any one of embodiments 1 to 5, further comprising a palladium-cobalt alloy. Embodiment 7 is the water-splitting photocatalyst of any one of embodiments 1 to 6, wherein the titanium dioxide is anatase, rutile, or brookite, or any combination thereof. Embodiment 8 is the water-splitting photocatalyst of embodiment 7, wherein the titanium dioxide is anatase. Embodiment 9 is the water-splitting photocatalyst of embodiment 7, wherein the titanium dioxide is a mixed-phase comprising anatase and rutile. Embodiment 10 is the water-splitting photocatalyst of embodiment 9, wherein the ratio of anatase to rutile is 1.5:1 to 10:1. Embodiment 11 is the water-splitting photocatalyst of any one of embodiments 1 to 10, wherein photoactive titanium dioxide, the hole-scavenging material, and the Pd are each in particulate form. Embodiment 12 is the water-splitting photocatalyst of embodiment 11, further comprising a palladium (Pd)-cobalt (Co) alloy that is in particulate form. Embodiment 13 is the water-splitting photocatalyst of embodiment 12, wherein the photoactive titanium dioxide, the hole-scavenging material, the Pd, and the Pd—Co alloy are each nanostructures or sub-nanostructures. Embodiment 14 is the water-splitting photocatalyst of embodiment 13, wherein the nanostructures are nanowires, nanoparticles, nanoclusters, or nanocrystals, or combinations thereof. Embodiment 15 is the water-splitting photocatalyst of any one of embodiments 1 to 14, wherein the hole-scavenging material is deposited on the surface of the photoactive titanium dioxide. Embodiment 16 is the water-splitting photocatalyst of embodiment 14, wherein the Pd is deposited on the surface of the photoactive titanium dioxide or the surface of the hole-scavenging material, or both surfaces. Embodiment 17 is the water-splitting photocatalyst of any one of embodiments 1 to 16, wherein the photocatalyst is capable of catalyzing the photocatalytic electrolysis of water.

Embodiment 18 is an aqueous composition comprising the water-splitting photocatalyst of any one of embodiments 1 to 17. Embodiment 19 is the aqueous composition of embodiment 18, wherein the aqueous composition has a pH of 7 to 13. Embodiment 20 is the aqueous composition of embodiment 19, wherein the aqueous composition has a pH of 9 to 10. Embodiment 21 is the aqueous composition of any one of embodiments 18 to 20, comprising 1 w/v % to 10 w/v % of a sacrificial agent solubilized in the aqueous composition. Embodiment 22 is the aqueous composition of any one of embodiments 18 to 20, comprising less than 1 w/v % or no sacrificial agent solubilized in the aqueous composition. Embodiment 23 is the aqueous composition of any one of embodiments 18 to 22, wherein the sacrificial agent is methanol, ethanol, propanol, butanol, iso-butanol, methyl tert-butyl ether, ethylene glycol, propylene glycol, glycerol, or oxalic acid, or any combination thereof. Embodiment 24 is the aqueous composition of embodiment 23, wherein the sacrificial agent is ethylene glycol or glycerol or a combination thereof. Embodiment 25 is the aqueous composition of any one of embodiments 18 to 24, comprising 0.1 to 2 g/L of the photocatalyst.

Embodiment 26 is an aqueous composition comprising a water-splitting photocatalyst having photoactive titanium dioxide loaded with 1.5 wt. % to 2.5 wt. % of a hole-scavenging material comprising cobalt oxide and a sacrificial agent solubilized in the aqueous composition, wherein the aqueous composition has a pH of 7 to 13. Embodiment 27 is the aqueous composition of embodiment 26, wherein the aqueous composition has a pH of 9 to 10. Embodiment 28 is the aqueous composition of any one of embodiments 26 to 27, comprising 1 w/v % to 10 w/v %, preferably 3 w/v % to 7 w/v %, or more preferably 4 w/v % to 6 w/v % of the sacrificial agent. Embodiment 29 is the aqueous composition of any one of embodiments 26 to 28, wherein the cobalt oxide is cobalt (II) oxide, cobalt (III) oxide, or cobalt (II, III) oxide. Embodiment 30 is the aqueous composition of embodiment 29, wherein the cobalt oxide is cobalt (II) oxide. Embodiment 31 is the aqueous composition of any one of embodiments 26 to 30, wherein the titanium dioxide is anatase, rutile, or brookite, or any combination thereof. Embodiment 32 is the aqueous composition of embodiment 31, wherein the titanium dioxide is anatase. Embodiment 33 is the aqueous composition of embodiment 31, wherein the titanium dioxide is a mixed-phase comprising anatase and rutile. Embodiment 34 is the aqueous composition of embodiment 33, wherein the ratio of anatase to rutile is 1.5:1 to 10:1. Embodiment 35 is the aqueous composition of any one of embodiments 26 to 34, wherein photoactive titanium dioxide and the hole-scavenging material are each in particulate form. Embodiment 36 is the aqueous composition of embodiment 35, wherein the photoactive titanium dioxide and the hole-scavenging material are each nanostructures. Embodiment 37 is the aqueous composition of embodiment 36, wherein the nanostructures are nanowires, nanoparticles, nanoclusters, or nanocrystals, or combinations thereof. Embodiment 38 is the aqueous composition of any one of embodiments 26 to 37, wherein the hole-scavenging material is deposited on the surface of the photoactive titanium dioxide.

Embodiment 39 is a water-splitting system for generating hydrogen and oxygen from water, the system comprising a reaction vessel comprising water and any one of the water-splitting photocatalysts of embodiments 1 to 17 or any one of the aqueous compositions of embodiments 18 to 38. Embodiment 40 is the water-splitting system of embodiment 39, further comprising a light source for irradiating the water. Embodiment 41 is the water-splitting system of embodiment 40, wherein the light source is sunlight or an artificial light source, or a combination thereof. Embodiment 42 is the water-splitting system of embodiment 41, wherein the artificial light source is an ultraviolet lamp or a Xenon lamp.

Embodiment 43 is a method for producing oxygen (O₂) and hydrogen (H₂) from water, the method comprising obtaining the aqueous composition of any one of embodiments 18 to 38 or the system of any one of embodiments 39 to 42, and subjecting the water having the photocatalyst to a light source for a sufficient period of time to produce O₂ and H₂ from the water. Embodiment 44 is the method of embodiment 43, wherein the photocatalyst comprises the photoactive titanium dioxide loaded with 0.5 wt. % to 4 wt. % of the hole-scavenging material comprising cobalt oxide and 0.1 wt. % to 1 wt. % of palladium (Pd). Embodiment 45 is the method of embodiment 44, wherein the photocatalyst comprises 1.5 wt. % to 2.5 wt. % cobalt oxide and 0.2 wt. % to 0.4 wt. % Pd. Embodiment 46 is the method of embodiment 45, comprising about 2 wt. % cobalt oxide and about 0.3 wt. % Pd. Embodiment 47 is the method of any one of embodiments 43 to 46, wherein the photocatalyst further comprises a palladium-cobalt alloy. Embodiment 48 is the method of any one of embodiments 43 to 47, wherein the hydrogen production rate is 1.5×10⁻⁴ to 2.5×10⁻⁴ mol/g_{Catal} min. Embodiment 49 is the method of embodiment 43, wherein the photocatalyst comprises the photoactive titanium dioxide loaded with 1.5 wt. % to 2.5 wt. % of the hole-scavenging material comprising cobalt oxide and no palladium (Pd). Embodiment 50 is the method of embodiment 49, wherein the hydrogen production rate is 1.5×10⁻⁵ to 2.5×10⁻⁵ mol/g_{Catal} min. Embodiment 51 is the method of any one of embodiments 43 to 50, wherein the reaction conditions include an ultraviolet light luminous flux of 3 to 7 mW/cm² and 30 mL of 5 vol % glycerol aqueous solution. Embodiment 52 is the method of any one of embodiments 43 to 51, wherein the light source is sunlight or an artificial light source, or a combination thereof. Embodiment 53 is the method of embodiment 52, wherein the artificial light source is an ultraviolet lamp or a Xenon lamp. Embodiment 54 is the method of any one of embodiments 43 to 53, wherein the ratio of H₂ to O₂ produced is from 8 to 50.

The following includes definitions of various terms and phrases used throughout this specification.

“Water-splitting” or any variation of this phrase describes the chemical reaction in which water is separated into oxygen and hydrogen.

“Inhibiting,” “preventing,” or “reducing” or any variation of these terms, when used in the claims or the specification includes any measurable decrease or complete inhibition to achieve a desired result. By way of example, reducing the likelihood for an excited electron in the conductive band to recombine with a hole in the valence band encompasses situations where a decrease in the number of electron/hole recombination events occurs or an increase in the time it takes for an electron/hole recombination event to occur such that the increase in time allows for the electron to reduce hydrogen ions rather than to recombine with its corresponding hole.

“Effective” or any variation of this term, when used in the claims or specification, means adequate to accomplish a desired, expected, or intended result.

“Nanostructure” refers to an object or material in which at least one dimension of the object or material is equal to or less than 1000 nm (e.g., one dimension is 1 to 1000 nm in size). In a particular aspect, the nanostructure includes at least two dimensions that are equal to or less than 1000 nm (e.g., a first dimension is 1 to 1000 nm in size and a second dimension is 1 to 1000 nm in size). In another aspect, the nanostructure includes three dimensions that are equal to or less than 1000 nm (e.g., a first dimension is 1 to 1000 nm in size, a second dimension is 1 to 1000 nm in size, and a third dimension is 1 to 1000 nm in size). The shape of the nanostructure can be of a wire, a particle, a sphere, a rod, a tetrapod, a hyper-branched structure, or mixtures thereof. In preferred instances, the nanostructures used to prepare the catalysts of the present invention are spherical or substantially spherical in shape.

The terms “about” or “approximately” are defined as being close to as understood by one of ordinary skill in the art. In one non-limiting embodiment the terms are defined to be within 10%, preferably within 5%, more preferably within 1%, and most preferably within 0.5%.

The terms “wt. %”, “vol. %”, or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The photocatalysts and photoactive materials of the present invention can “comprise,” “consist essentially of,” or “consist of” particular components, compositions, ingredients, etc. disclosed throughout the specification. With respect to the transitional phase “consisting essentially of,” in one non-limiting aspect, a basic and novel characteristic of the photoactive catalysts and materials of the present invention is the amount of cobalt oxide and palladium loaded onto the titanium dioxide. These amounts include 0.5 wt. % to 4 wt. %, preferably 1.5 wt. % to 2.5 wt. %, and most preferably about 2 wt. % of cobalt oxide and 0.1 wt. % to 1 wt. %, preferably 0.2 wt. % to 0.4 wt. %, and most preferably about 0.3 wt. % palladium loaded onto the titanium dioxide.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description.

### BRIEF DESCRIPTION OF THE DRAWINGS

FIGS. 1A-C: (a) Schematic of a cross-sectional view of a photocatalyst of the present invention where photoactive titanium dioxide is impregnated with cobalt oxide. (b and c) Schematics of a cross-sectional view of photocatalysts of the present invention where photoactive titanium dioxide is impregnated with cobalt oxide and palladium.

FIG. 2: Schematic of a water splitting system of the present invention where the photoactive catalyst is dispersed in an aqueous solution.

FIGS. 3A and 3B: (3A) UV-Vis absorption spectra of TiO₂ photocatalyst with different loadings of Co (in wt. %) (i) 0 (ii) 0.5 (iii) 1 (iv) 2 and (v) 4%. (3B) Plots of Tauc units versus (eV) for same series of photocatalysts.

FIGS. 4A-C: (4A) XRD spectra of TiO₂ with different loadings of Co (in wt %). (4B) XPS spectra of Co 2p peak in CoOₓ-loaded TiO₂ containing 1.0 wt % cobalt before and after Ar ions sputtering. (4C) Valence band of the same samples of (4B), before sputtering (“red line”) and after sputtering (“black line”). The inset in (4C) represents the corresponding Ti2p and O2s lines.

FIGS. 5A-D: (5A) H₂ production as a function of time over TiO₂ with different loadings of Co (in wt %). (5B) H₂ production rates (extracted from (5A)) as function of Co loading. Reaction conditions: 4 mg catalyst, 30 mL H₂O and 5 vol % glycerol under UV lamp (375 nm) at a flux of 4 mW/cm² (measured after a Pyrex with a similar thickness to that of the reactor). (5C) O₂ evolution from TiO₂ with different loadings of Co (in wt %) using 0.05 M AgNO₃ solutions (5B) O₂ evolution rates as function of Co loading. (5D) O₂ production rates (extracted from (5C)) as function of Co loading.

FIGS. 6A-D: (6A) H₂ production as a function of time of TiO₂ photocatalysts with different loadings of Co (in wt. %). (6B) H₂ production rates as a function of Co loading. Reaction conditions: 4 mg catalyst, 30 mL H₂O and 5 vol % glycerol under Xenon lamp (250-650 nm) with a total flux of 26 mW/cm² (UV about 3.3 mW/cm², visible about 22.7 mW/cm²). (6C) H₂ production rates (normalized to UV flux) for UV lamp versus UV plus Visible lamp as function of Co loading. (6D) % drop in activity on using 1% glycerol as function of Co loading.

FIG. 7: Proposed mechanism for the photocatalytic hydrogen evolution over Coo loaded TiO₂ photocatalyst.

FIGS. 8A and 8B: (8A) H₂ production as a function of time of 2 wt. % Co—TiO₂ photo-catalyst with different loadings of Pd (in wt. %). (8B) H₂ production rates of 2 wt. % Co—TiO₂ with different loadings of Pd (in wt. %).

FIGS. 9A-C: (9A) high angle annular dark field imaging (HAADF) in STEM mode of TiO₂ (anatase) particles. (9B) high angle annular dark field imaging (HAADF) in STEM mode of 0.3 wt. % Pd-2 wt. % CoO/TiO₂ particles; the inset presents EDS from two distinct particles. (9C) high angle annular dark field imaging (HAADF) in STEM mode of 0.3 wt. % Pd-2 wt. % CoO/TiO₂ particles; inset shows the particle size distribution.

### DETAILED DESCRIPTION OF THE INVENTION

While hydrogen-based energy from water has been proposed by many as a solution to the current problems associated with carbon-based energy (e.g., limited amounts and fossil fuel emissions), the currently available technologies are expensive, inefficient, and/or unstable. The present invention provides a solution to these issues. The solution is predicated on the discovery that titanium dioxide particles impregnated with certain amounts of cobalt oxide and palladium or palladium-cobalt alloy can dramatically enhance hydrogen and oxygen production rates from a water-splitting reaction. Without wishing to be bound by theory, it is believed that when cobalt oxide and palladium or Pd—Co alloy are each used in amounts of 0.5 wt. % to 4 wt. % and 0.1 wt. % to 1 wt. % by weight of the total catalyst, respectively, an increase in the charge carrier life time of the electrons and holes occurs, which leads to an increase in hydrogen and oxygen production rather than an electron-hole recombination event. As illustrated in non-limiting embodiments in the Examples and Figures, maximum H₂ and O₂ production can be obtained when cobalt oxide is used in amounts of 1.5 wt. % to 2.5 wt. %, preferably about 2 wt. %, and palladium (or a combination of Pd and Pd—Co) is used in amounts of 0.2 wt. % to 0.4 wt. %, preferably about 0.3 wt. %, of the total weight of the catalyst. Stated plainly critical amount ranges for both of cobalt oxide and palladium have been discovered in the present invention. Still further, it was also discovered that cobalt oxide can act as a hole scavenging agent much like sacrificial agents (e.g., glycerol and ethylene glycol) do. Therefore, the catalysts of the present invention, when used in a water-splitting reaction, do not need to rely on the presence of solubilized sacrificial agents in the aqueous solution to reduce the likelihood of electron-hole recombination events. This can make the catalysts of the present invention more cost efficient and less complicated to use when compared with other known water-splitting catalysts.

These and other non-limiting aspects of the present invention are discussed in further detail in the following sections.

### A. Photoactive Catalysts

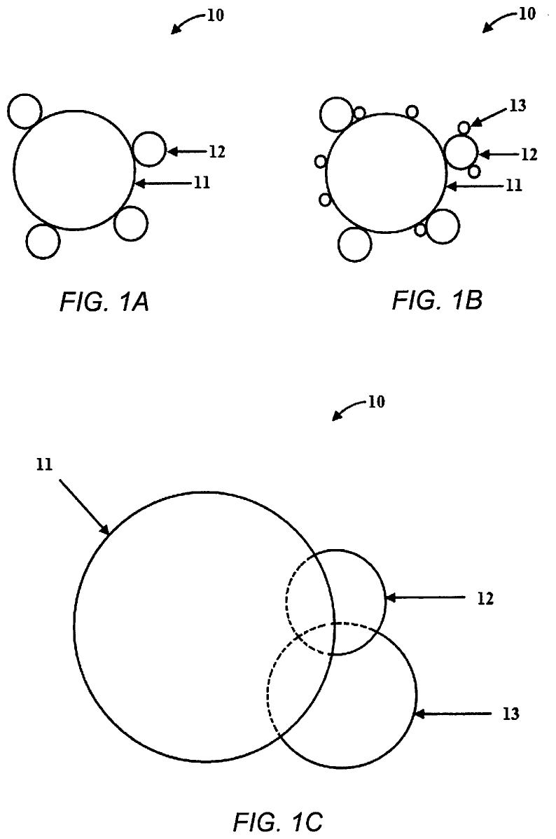

Referring to FIGS. 1A and 1B, water-splitting photoactive catalysts 10 of the present invention are illustrated through non-limiting illustrations. The size and shape of the catalysts 10, which include photoactive titanium 11, cobalt oxide 12, and palladium 13 are non-limiting and used only for illustration purposes. In one instance, the catalyst 10 can include a photoactive titanium dioxide particle 11 that is impregnated with cobalt oxide 12 such that cobalt oxide 12 is present on the surface of the titanium dioxide 11. This can allow for the formation of interfaces between the titanium dioxide particle 11 and the cobalt oxide particles 12 (See, FIG. 1A). Alternatively, the catalyst 10 can be further impregnated with palladium 13 such that palladium particles 13 are present on the surfaces of the titanium dioxide particle 11 and/or on the surface of the cobalt oxide particle 12 (See, FIG. 1B). This can allow for the formation of interfaces between palladium particles 13 and titanium dioxide particle 11 or palladium particles 13 and cobalt oxide particles 12. In some instances, an individual cobalt oxide particle 13 can contact both surfaces of the titanium dioxide particle 11 and a cobalt oxide particle 12 at the same time. The size and shapes of each of the titanium dioxide particle 11, the cobalt oxide particles 12, and the palladium particles 13 can be modified as desired. In particular instances, each of the particles 11, 12, and 13 are nanostructures. In preferred aspects, the titanium dioxide particle 11 is substantially spherical in shape and has a diameter of 7 to 10 nm, while the palladium particle 13 is also substantially spherical in shape with a diameter of 1 to 2 nm, and the cobalt oxide particle 12 is typically sub-nanometers in size up to particles having a diameter of 3 nm or 1 to 3 nm.

One of the discoveries of the present invention are the weight percentage ranges of cobalt oxide particles 12 and palladium particles 13 that are included in the catalyst 10. In particular, cobalt oxide particles 12 can be present in an amount of 0.5 wt. % to 4 wt. % based on the total weight of the catalyst 10. In preferred instances, the cobalt oxide particles 12 are present in an amount of 1.5 wt. % to 2.5 wt. %, and most preferably about 2 wt. %, based on the total weight of the catalyst 10. The palladium particles 13 can be present in an amount of 0.1 wt. % to 1 wt. % based on the total weight of the catalyst 10. Still further, the palladium particles 13 can be a combination of Pd particles and Pd—Co alloy particles, both of which are represented as element 13. The Pd particles can be separate from the Pd—Co alloy particles. In preferred instances, the palladium particles 13 are present in an amount of 0.2 wt. % to 0.4 wt. %, and preferably about 0.3 wt. %, based on the total weight of the catalyst 10. It is believed that these weight percentage ranges provides for maximum catalytic activity of the catalysts 10 of the present invention. Still further, the discovery of the cobalt oxide particles 12 acting as hole scavengers allows for one to limit or avoid the use of sacrificial agents during a water-splitting reaction.

Still further, the catalysts 10 of the present invention can be further impregnated with additional materials that further enhance the efficiency of the water-splitting reaction and ultimate production of H₂ and/or O₂. By way of example, further impregnation with metals or oxides or alloys thereof can assist in reducing or preventing electron/hole recombination events. Non-limiting examples of such metals include silver, platinum, gold, rhodium, ruthenium, rhenium, iridium, nickel, or copper, or any combinations or oxides or alloys thereof. These additional metals can be nanostructures, preferably nanoparticles having a substantially spherical shape.

1. Materials Used

The photoactive titanium dioxide 11 can be capable of being excited by ultraviolet and/or visible light. The titanium dioxide can be in the form of three phases, the anatase phase, the rutile phase, and the brookite phase. Anatase and rutile phases have a tetragonal crystal system, whereas the brookite phase has an orthorhombic crystal system. While anatase and rutile both have a tetragonal crystal system consisting of TiO₆ octahedra, their phases differ in that anatase octahedras are arranged such that four edges of the octahedras are shared, while in rutile, two edges of the octahedras are shared. Anatase can be more efficient than rutile in the charge transfer, but may not be as durable as rutile. Each of the different phases can be purchased from various manufactures and supplies (e.g., titanium (IV) oxide anatase nanopowder and titanium (IV) oxide rutile nanopowder in a variety of sizes and shapes can be obtained from Sigma-Aldrich® Co. LLC (St. Louis, Mo., USA) and from Alfa Aesar GmbH & Co KG, A Johnson Matthey Company (Germany)); all phases of titanium dioxide from L.E.B. Enterprises, Inc. (Hollywood, Fla. USA)). They can also be synthesized using known sol-gel methods (See, for example, Chen et al., Chem. Rev. 2010 Vol. 110, pp. 6503-6570, the contents of which are incorporated herein by reference). In preferred instances, the titanium dioxide 11 is pure anatase or a mixed phase of anatase and rutile.

The cobalt oxide particles 12 (CoOₓ) can be in the form of cobalt(II) oxide (CoO), cobalt(III) oxide (Co₂O₃), or cobalt(II,III) oxide (Co₃O₄). In preferred instances, the cobalt oxide 12 particles are in the reduced form of CoO. The cobalt oxide can be obtained from a variety of commercial sources in a variety of forms (e.g., particles, rods, films, etc.) and sizes (e.g., Nano scale or Micro scale). By way of example, each of Sigma-Aldrich® (U.S.A.) and Alfa Aesar GmbH (Germany) offer such products. Alternatively, they can be made by any process known by those of ordinary skill in the art such as precipitation or impregnation methods.

The palladium particles 13 can be palladium or an alloy that includes palladium. In preferred instances, the palladium is used. Palladium can be obtained from a variety of commercial sources in a variety of forms (e.g., particles, rods, films, etc.) and sizes (e.g., Nano scale or Micro scale). By way of example, each of Sigma-Aldrich® (U.S.A) and Alfa Aesar GmbH (Germany) offer such products. Alternatively, they can be made by any process known by those of ordinary skill in the art. In a non-limiting aspect, the palladium particles can be prepared using co-precipitation or deposition-precipitation methods. The palladium particles 13 can be used as conductive material for the excited electrons to ultimately reduce hydrogen ions to produce hydrogen gas. Palladium particles 13 are highly conductive materials, making them well suited to act in combination with the photoactive material 11 to facilitate transfer of excited electrons to hydrogen before an electron-hole recombination event occurs or by increasing the time that such an event occurs.

2. Process of Making the Photocatalysts

Non-limiting examples for making photocatalysts are disclosed in the Examples of the present specification. Generally, the following steps can be used to manufacture catalysts of the present invention.

The water-splitting photoactive catalysts 10 of the present invention can be prepared from the aforementioned titanium dioxide particles 11, the cobalt oxide particles 12, and the palladium particles 13 by using the process described in the Examples section of this specification. A non-limiting example of a method that can be used to make the photoactive catalysts 10 includes formation of an aqueous solutions of titanium dioxide particles 11 in the presence of cobalt oxide particles 12 followed by precipitation where the cobalt oxide particles 12 are attached to a least a portion of the surface of titanium dioxide particles 11 (e.g., precipitated titanium dioxide crystals or particles 11, 12). Deposition or impregnation of palladium particles 13 can be obtained by mixing the titanium dioxide-cobalt oxide composite with aqueous solutions of palladium or salt forms or precursors thereof, followed by precipitation, where the palladium particles 13 become attached to at least a portion of the surface of titanium dioxide-cobalt oxide composite. Alternatively, the palladium particles 13 can be deposed on the surface of the composite titanium dioxide-cobalt oxide composite material by any process known by those of ordinary skill in the art. Deposition can include attachment, dispersion, and/or distribution of the palladium particles 13 on the surface of the titanium dioxide particle 11, the cobalt oxide particles 12, or both. As another non-limiting example, the titanium dioxide-cobalt oxide composite material can be mixed in a volatile solvent with the palladium particles 13. After stirring and sonication, the solvent can be evaporated off. The dry material can then be ground into a fine powder and calcined (such as at 300° C.) to produce the photoactive catalysts 10 of the present invention. Calcination (such as at 300° C.) can be used to further crystalize the titanium dioxide-cobalt oxide composite material. FIG. 1C is a schematic representation of the photocatalyst that includes the titanium dioxide particle 11, the cobalt oxide particle 12, and the palladium particle 13. The titanium dioxide particle 11 is in contact with the cobalt oxide particle 12. The palladium particle is in contact with both of the titanium dioxide particle 11 and the cobalt oxide particle 12.

B. Water-Splitting System

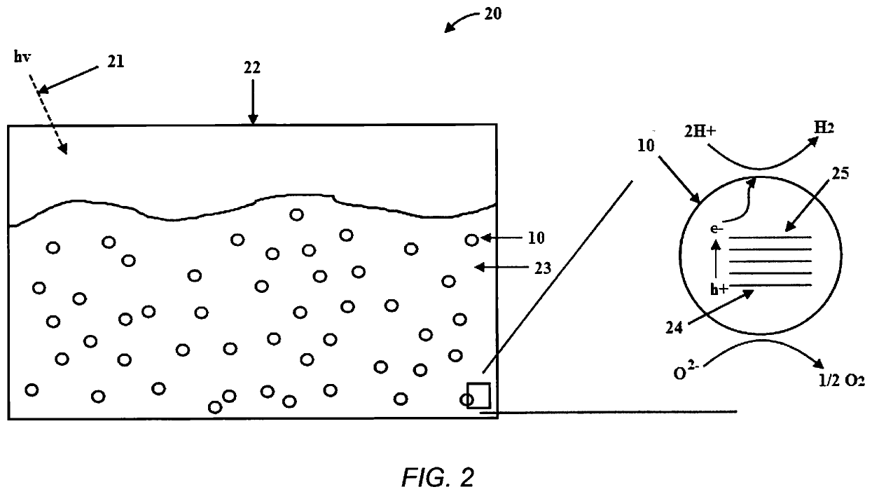

Referring to FIG. 2, a non-limiting representation of a water-splitting system 20 of the present invention is provided. The system includes a plurality of the photocatalysts 10, a light source 21, and container or reaction vessel 22 that can be used to hold aqueous solutions or water 23. The plurality of photocatalysts 10 can be suspended in the aqueous solution 23. Although not shown, the system 20 can also include at least one inlet for the aqueous solution/water 23 and at least one or more outlets for produced hydrogen and oxygen formed during the water-splitting reaction. Although not shown, the photocatalyst 10 can be coated onto the walls of the container 22 or can be packed in a bed (or plurality of beds), which is then immersed in the aqueous solution 23.

The container 22 can be a transparent, translucent or even opaque such as those that can magnify light (e.g., opaque container having a pinhole(s)). The photocatalyst 10 can be used to split water to produce H₂ and O₂. The light source 21 can includes either one of or both of visible and (400-600 nm) and ultraviolet light (280-400). The light can excite the photoactive titanium dioxide 11 to excite an electron in the valence band 24 to the conductive band 25. The excited electrons (e⁻) leave a corresponding hole (h⁺) when the electrons move to the conductive band. The excited electrons (e⁻) are used to reduce hydrogen ions to form hydrogen gas, and the holes (h⁺) are used to oxidize oxygen ions to oxygen gas. In particular, the cobalt oxide 12 can act as a hole scavenger to oxidize oxygen anions and produce O₂. Palladium 13 can act as an electron sink to reduce protons and produce H₂. The hydrogen gas and the oxygen gas can then be collected and used in down-stream processes. Due to the hole scavenging properties of the cobalt oxide and conductive properties of palladium, excited electrons (e⁻) are more likely to be used to split water before recombining with a hole (h⁺) than would otherwise be the case. The system 20 does not require the use of an external bias or voltage source. Further, the efficiency of the system 20 as well as the hole scavenging properties of cobalt oxide allows for one to avoid or use minimal amounts of a sacrificial agent such as methanol, ethanol, propanol, butanol, isobutanol, methyl tert-butyl ether, ethylene glycol, propylene glycol, glycerol, oxalic acid, or any combination thereof. In certain aspects, however, 0.1 to 10 w/v %, or preferably 2 to 7 w/v %, of a sacrificial agent can be included in the aqueous solution 23. The presence of the sacrificial agent can increase the efficiency of the system 20 by further reducing the likelihood of hole/electron recombination via oxidation of the sacrificial agent by the hole rather than recombination with the excited electron. Preferred sacrificial agents ethylene glycol, glycerol, or a combination thereof is used.

In addition to being capable of catalyzing water splitting without an external bias or voltage, the photocatalysts of the present invention may be included in an anode of an electrochemical cell capable of forming oxygen and hydrogen by electrolysis of water. In a non-limiting example, light energy may be provided to a photocell and from the light energy a voltage between the anode and the cathode is produced and water molecules are split to form hydrogen and oxygen. The method can be practiced such that the hydrogen production rate from water can be modified as desired by subjecting the system to various amounts of light energy or light flux. For example, the photoactive catalyst 10 can be used as the anode in a transparent container containing an aqueous solution and used in a water-splitting system. An appropriate cathode can be used such as Mo—Pt cathodes (See, International Journal of Hydrogen Energy, June 2006, Vol. 31, issue 7, pages 841-846) or MoS₂ cathodes (See, International Journal of Hydrogen Energy, February 2013, Vol. 38, issue 4, pages 1745-1757).

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Preparation of Photocatalysts

The CoOₓ—TiO₂ photocatalysts were prepared by wet impregnation. Anatase TiO₂ from Hombikat was used as the support catalyst. Different loadings of Co (0, 0.5, 1, 2 and 4 wt. %) on TiO₂ support were prepared by adding known amount of Co(NO₃)₂.6H₂O salt solution to 500 mg of TiO₂ support. Excess water was evaporated to dryness under constant stirring with slow heating at 80° C. The dried photocatalysts was calcined at 350° C. for 5 hours to improve the crystallinity.

Photocatalysts with dual co-catalysts of Pd and CoOₓ were prepared by co-impregnating the Pd and Co salt solutions in the same way. Pd acetate as well as Pd chloride were both used as precursors for Pd metal deposition. Both gave Pd metal of about the same particle size.

### Example 2

### Characterization Data

UV-VIS absorbance spectra of the powdered catalysts was collected over the wavelength range of 250-900 nm on a Thermo Fisher Scientific spectrophotometer equipped with praying mantis diffuse reflectance accessory. Absorbance (A) and reflectance (% R) of the samples were measured. The reflectance (% R) data was used to calculate the band gap of the samples using the Tauc plot (Kubelka-Munk function). The crystal structure and phase of our photocatalysts was characterized using X-ray diffraction (XRD). XRD spectra was recorded using a Bruker D8 Advance X-ray diffractometer. A 2θ interval between 20 and 90° was used with a step size of 0.010° and a step time of 0.2 sec/step. X-ray photoelectron spectroscopy (XPS) was used to study the elemental composition and electronic state of our photo-catalysts. XPS was conducted using a Thermo scientific ESCALAB 250 Xi. The base pressure of the chamber was typically in the low 10⁻⁹ to high 10⁻¹⁰ mbar range. Charge neutralization was used for all samples. Spectra were calibrated with respect to C1s at 285.0 eV. Quantitative analyses were conducted using the following sensitivity factors: Co2p (3.8), Ti2p (1.8), and O1s (0.66).

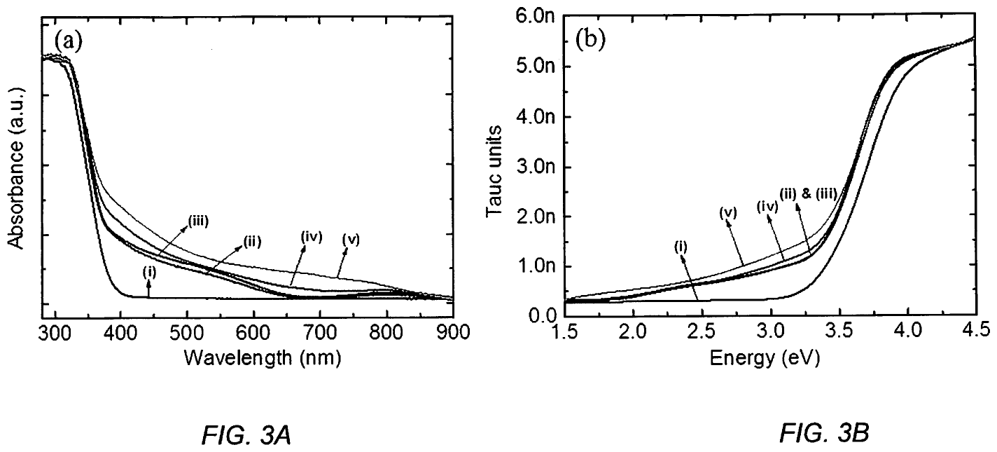

The band gaps and absorption properties of the prepared photocatalysts were studied using diffuse reflectance UV-Vis spectroscopy. The UV-Vis spectra of CoOₓ—TiO₂, recorded in the range of 250 nm to 900 nm as shown in FIG. 3A. The UV-Vis spectra shows typical absorption from anatase TiO₂ with a band edge around 370 nm (E_{g} about 3.35 eV) due to the charge-transfer from the valence band formed by 2p orbitals of the oxide anions to the conduction band formed by 3d t2g orbitals of the Ti⁴⁺ cations (See, Sadanandam et al., “Cobalt doped TiO2: A stable and efficient photocatalyst for continuous hydrogen production from glycerol:Water mixtures under solar light irradiation”, Int. J. Hydrogen. Energ. 2013, 38, 9655-9664 (“Sadanandam”), Yan et al., “Noble metal-free cobalt oxide (CoOx) nanoparticles loaded on titanium dioxide/cadmium sulfide composite for enhanced photocatalytic hydrogen production from water”, Int. J. Hydrogen. Energ. 2014, 39, 13353-13360) (“Yan”)). Absorption spectra of CoOₓ—TiO₂ nanocomposite photocatalysts showed a red shift in the absorption with broad absorption in visible light. The nanocomposite catalysts also show an absorption peak in the region of 500 nm (about 2.5 eV) which can be attributed to Co²⁺→Ti⁺ charge-transfer interaction, consistent with earlier reports (see Sadanandam and Yan). The other absorption peak near 800 nm (about 1.5 eV) is caused by the transition of electrons from the occupied Co 3d states below the Fermi level to the uncopied Co 3d states which form the conduction band of CoOₓ (See, Deori et al., “Morphology oriented surfactant dependent CoO and reaction time dependent Co3O4 nanocrystals from single synthesis method and their optical and magnetic properties”, CrystEngComm 2013, 15, 8465-8474, and Liao et al., “Efficient solar water-splitting using a nanocrystalline CoO photocatalyst”, Nat. Nanotechnol. 2014, 9, 69-73).

The Kubelka-Munk function, F(R)=(1−R)2/(2R), was used to calculate the band gap of the materials. Since TiO₂ (anatase) is known to be an indirect band gap semiconductor, the Tauc plot of the quantity (F(R)×E)^{1/2} was plotted against the radiation energy and is shown in FIG. 3(b). Pure anatase TiO₂ has a band gap of 3.3 eV and with Co loading it slightly shifts to 3.2 eV. With increasing Co loading, there is no significant change in band gap of TiO₂ but at the same time the composite photocatalyst shows increased visible light absorption due to the presence of CoOₓ.

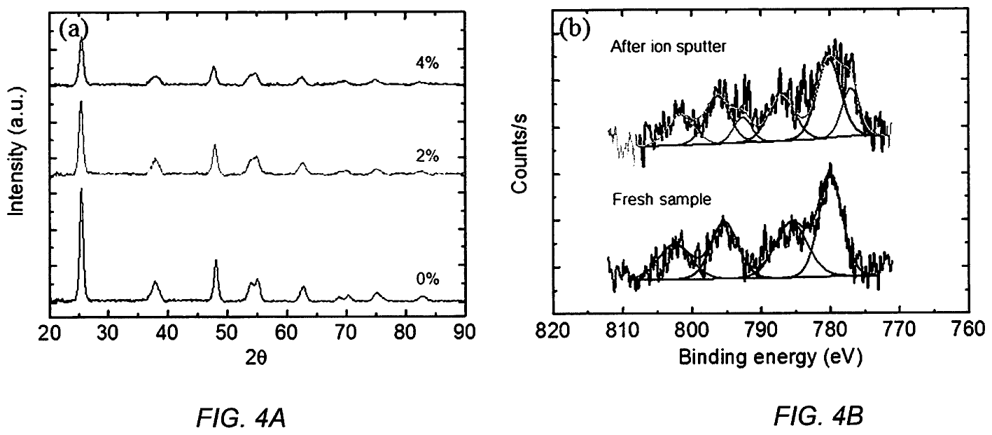

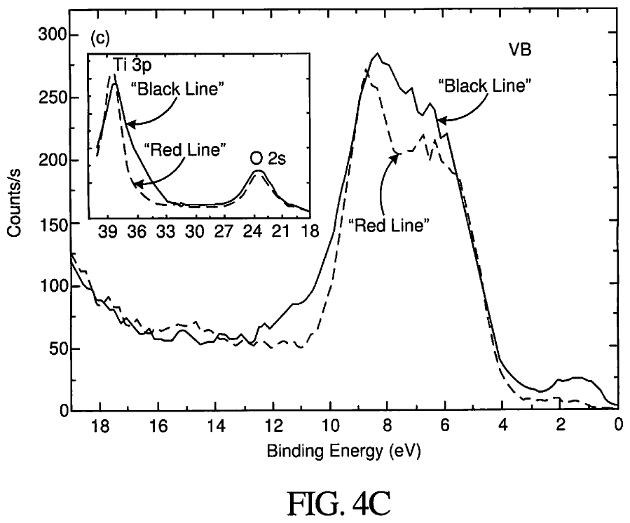

The effect of Co loading on crystal structure of TiO₂ support was studied using XRD. FIG. 4A shows the X-Ray diffraction patterns of TiO₂ photocatalyst with different loadings of Co (in wt. %). The XRD patterns clearly show the characteristic planes of anatase phase at 2θ=25.5° (101), 37.7° (004) and 48.2° (200). The XRD pattern does not show any cobalt phase (up to 4 wt. % loading), indicating that cobalt ions are uniformly dispersed on the TiO₂ support. This was also observed in earlier reports where at low loadings the CoO diffraction peaks could not be detected (See, Sadanandam and Yan). The XRD peaks positions of anatase TiO₂ also do not show any change upon Co loading, confirming there is no change in structure/crystal phase of TiO₂ or doping of Co ions into TiO₂. A broadening of the TiO₂ diffraction peaks was observed with addition of Co, indicated by the larger FWHM. This broadening could be due to smaller TiO₂ crystallites and/or lattice strain on TiO₂ due to the presence of CoO nanoparticles.

In order to further analyze chemical composition of CoO and electronic state of the composites, the CoOₓ-loaded TiO₂ sample was analyzed by XPS. FIG. 4B shows the Co 2p spectra from 1 wt. % CoOₓ—TiO₂ samples calcined at 400° C. for 5 hours. Co2p of Co²⁺ has its characteristic satellites, reduction of Co²⁺ leads to Co⁰ which results in a shift in the binding energy by about 2 eV. The binding energy of Co³⁺ is very close to that of Co²⁺ but Co³⁺ satellites are much more attenuated and therefore the presence of strong satellites can gauge the extent of Co²⁺ contribution (See, Idriss et al., “Reactions of Acetaldehyde on CeO₂ and CeO₂-Supported Catalysts”, J. Catal. 1995, 155, 219-237). In FIG. 4B XPS Co2p before and after Ar ion sputtering is presented. The binding energies for Co2p_{3/2} and Co2_{1/2} appear at 781.4 eV and 797.1 eV. A spin orbit splitting of 15.5 eV and satellites presence at about 7 eV above the main peaks (about 788 and 804 eV) are also observed. These structures are consistent with those reported for Co⁺² of CoO (See, Sadanandam). Argon ions sputtering results in the preferential removal of oxygen anions (See Idriss et al., “Characterization of TiO₂ surfaces active for novel organic synthesis”, Catal. Lett. 1994, 26, 123-139) and consequently the reduction of metal cations to lower oxidation states. This can be seen in FIGS. 4(b) and 4(c). In FIG. 4B, a shoulder at the lower binding energy side is seen at about 778 eV that is attributed to CoO. The appearance of CoO is associated with the decrease of the signal of Co²⁺. In FIG. 4C, the valance band region is presented for the fresh and Ar ions sputtered surfaces. The appearance of the lines at about 1 eV below the Fermi level is indicative of 3d electrons due to both Ti cations in reduced states (See, Idriss et al., “Two routes to formaldehyde from formic acid on TiO2 (001) surfaces”, Surf Sci., 1996, 348, 39-48) and metallic Co (See, Biesinger et al., “Resolving surface chemical states in XPS analysis of first row transition metals, oxides and hydroxides: Cr, Mn, Fe, Co and Ni”, Applied Surface Science, 2011, 257:2717-2730, and Riva et al., “Metal-support interaction in Co/SiO2 and Co/TiO2”, Applied Catalysis A: General, 2000, 196, 111-123). The inset in FIG. 4C presents the Ti3p and O2s for the same samples. The broad structure at the low binding energy side of the Ti3p is due to the presence of Ti cations in lower oxidation state than +4. Quantitative analyses of the Co2p, Ti2p, O1s indicated that Co is present is present in about 0.1 at. % on the TiO₂ support.

### Example 3

### Photocatalytic Activity

The photocatalysts were evaluated for H₂ production in a 135 mL volume Pyrex glass reactor. The catalyst sample (4 mg) was introduced into the reactor. Milli-Q® (Millipore Corp., U.S.A.) deionized water (30 mL) and glycerol (5 vol. %, 1.5 mL) as sacrificial agent was added. The final slurry was purged with N₂ gas to remove any O₂ and subjected to constant stirring. The reactor was then exposed to the UV light; a 100 Watt ultraviolet lamp (H-144GC-100, Sylvania par 38) with a flux of about 5 mW/cm² at a distance of 5 cm. Product analysis was performed by gas chromatograph (GC) equipped with thermal conductivity detector (TCD) connected to Porapak Q packed column (2 m) at 45° C. and N₂ was used as a carrier gas.

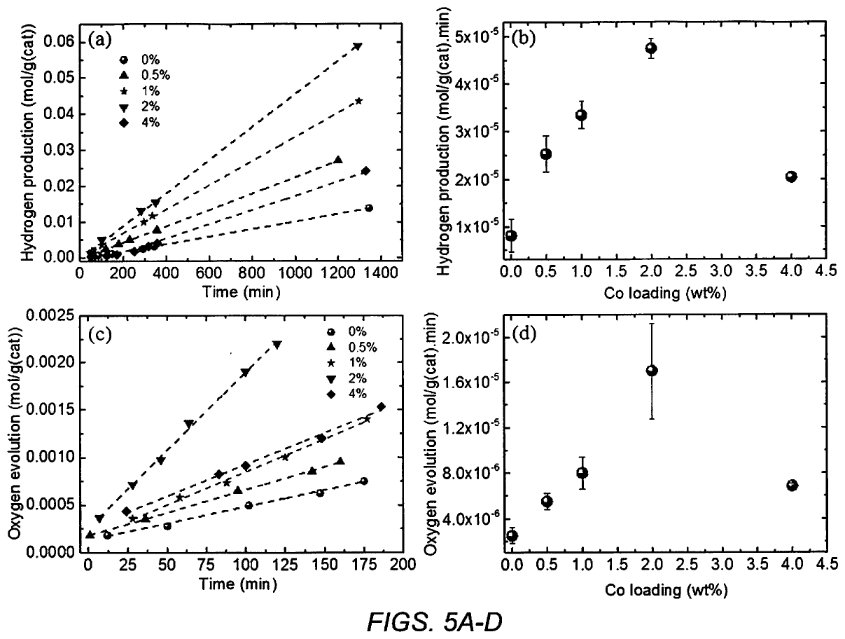

The H₂ production activity of CoOₓ—TiO₂ photo-catalysts under UV lamp from water-glycerol (5 vol. %) mixtures is shown in FIG. 5A. The photocatalytic activity from the composite photocatalysts was evaluated over 24 hours and was stable and reproducible. Pure anatase TiO₂ calcined at 350° C. showed H₂ production rates of about 10 μmolg⁻¹min⁻¹. The loading of CoOₓ resulted in a substantial improvement in the H₂ evolution. The highest H₂ production rates of about 47 μmolg⁻¹min⁻¹ was achieved when the Co metal concentration was 2 wt. % relative to TiO₂. The H₂ production rates as a function of Co loading is plotted in FIG. 5(b). One can notice that increasing the Co loading above 2 wt. %, decreased the photocatalytic activity. In order to further check for this activity, O₂ evolution activity of the catalysts was also analyzed under UV excitation condition and in the same reactor but with 0.05 M AgNO₃ solutions to scavenge electrons. As shown in FIG. 5C, the O₂ evolution was linear as a function of time and was observed to be in a stoichiometric ratio of 1:2 to the H₂ production seen earlier with glycerol as the sacrificial agent. The O₂ evolution also showed a similar trend to the H₂ production as shown in FIG. 5D with the 2 wt. % Co loading had the highest activity (about 21 μmolg⁻¹min⁻¹).

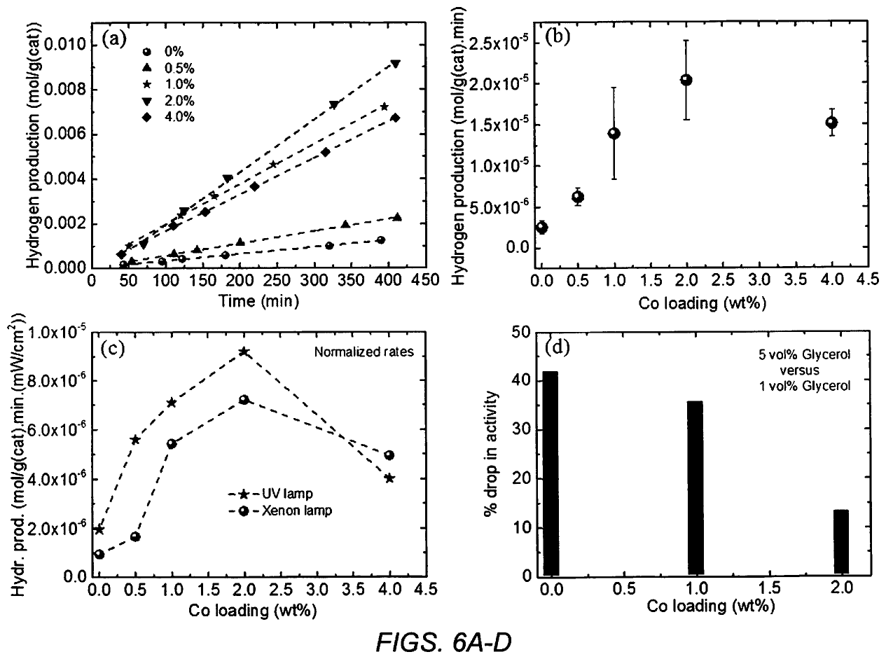

To further investigate the contribution of CoOₓ in the enhancement of photocatalytic activity, the reaction was also tested under UV plus visible light irradiation under a total flux of about 26 mW/cm² (UV about 3.3 mW/cm² and visible about 22.7 mW/cm²). As shown in FIG. 6A, similar to the trend under UV lamp, the loading of cobalt on TiO₂ resulted in a substantial improvement in the H₂ evolution. The highest H₂ production rates was also achieved when the Co concentration was 2 wt. % as seen in FIG. 6B. FIG. 6C presents the H₂ production rates normalized to UV flux where similar trends of activity, under UV light only and UV plus visible light, are seen. This indicates that there is no contribution of visible light charge carriers in the photocatalytic water splitting process. The results indicate that any charge carriers being generated in CoOₓ from visible light do not participate in the photocatalytic water splitting process. It is highly likely that in this case Co²⁺ are transformed to Co³⁺ during the hydrogen reduction process; in other words, this is a stoichiometric and not a catalytic reaction.

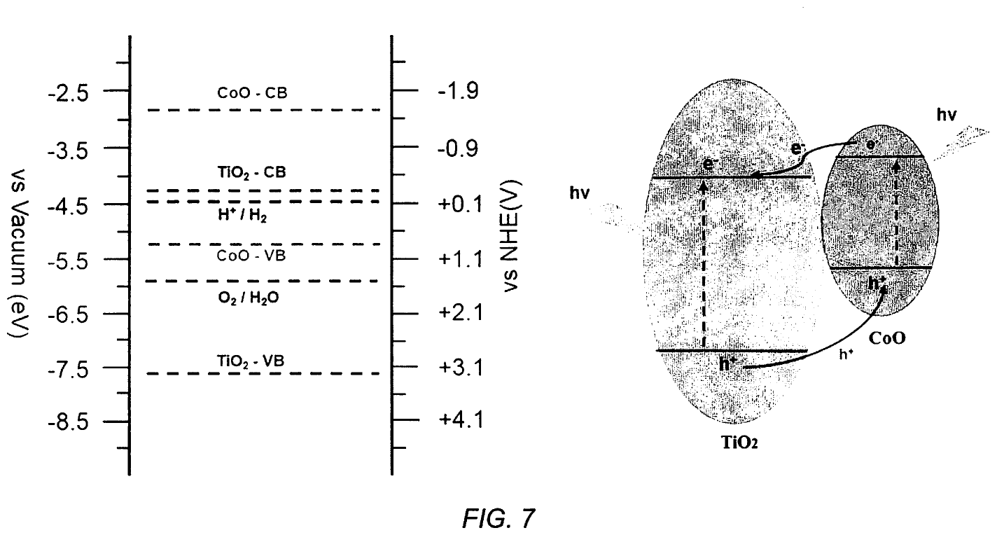

It is possible that the enhanced photocatalytic activity of the composite catalysts is due to the formation of a Schotkky type heterojunction leading to efficient charge carrier separation. The high valence band edge in CoOₓ is ideal for trapping photogenerated holes in TiO₂. The proposed mechanism is shown in FIG. 7 where the CoOₓ nanoparticles act as oxidation co-catalyst. This suggests that UV may aid in the excitation of TiO₂. To confirm this hypothesis, the photocatalysts were tested by changing the concentration of the “hole scavenging” sacrificial agent. In particular, photocatalytic activity under the same conditions by lowering the glycerol concentration from 5 vol % to 1 vol. % was analyzed. As shown in FIG. 6D, in pure anatase TiO₂, the H₂ evolution rates drop by about 42% when glycerol concentration is reduced to 1 vol. %. In contrast, samples with 2 wt. % of CoOₓ show better activity, with a drop of about 10%. This result may indicate that CoOₓ nanoparticles function similar to the sacrificial agent, i.e., as an oxidation co-catalyst/hole trapping agent.

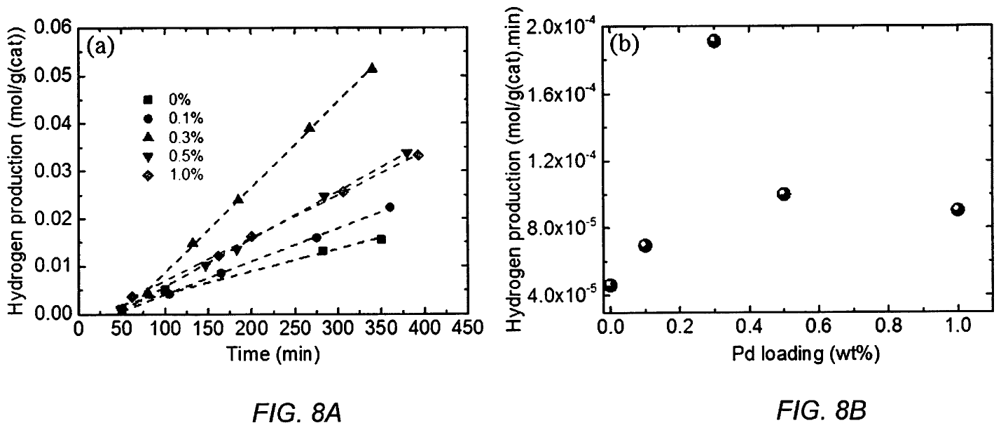

H₂ production activity of 2 wt. % CoOₓ—TiO₂ photocatalysts impregnated with Pd metal is shown in FIG. 8A. It was observed that upon loading Pd metal, H₂ evolution can be further improved. The highest H₂ production rates was achieved when the Pd concentration was 0.3 wt. % as seen in FIG. 8B, with H₂ production rates of about 180 μmolg⁻¹min⁻¹. This illustrates that a system where a dual semiconductor-based co-catalyst, i.e., CoOₓ as an oxidation co-catalyst and Pd as reduction co-catalyst, can function remarkably well and remain stable during extended periods of use.

To further investigate the role of Pd, Transmission Electron Microscopy (TEM) was performed on the catalyst having 0.3 wt. % Pd-2 wt. % CoO/TiO₂. Characterization by high resolution TEM (HRTEM) did not yield images where cobalt and/or palladium particles were visible; therefore it was necessary to use high angle annular dark field imaging (HAADF) in STEM mode, which is suited to better identify nanoparticles with higher atomic number than the support. The reason for that is that the nanoparticles are very small, so the number of atomic planes is low and lattice fringes are difficult to observe.

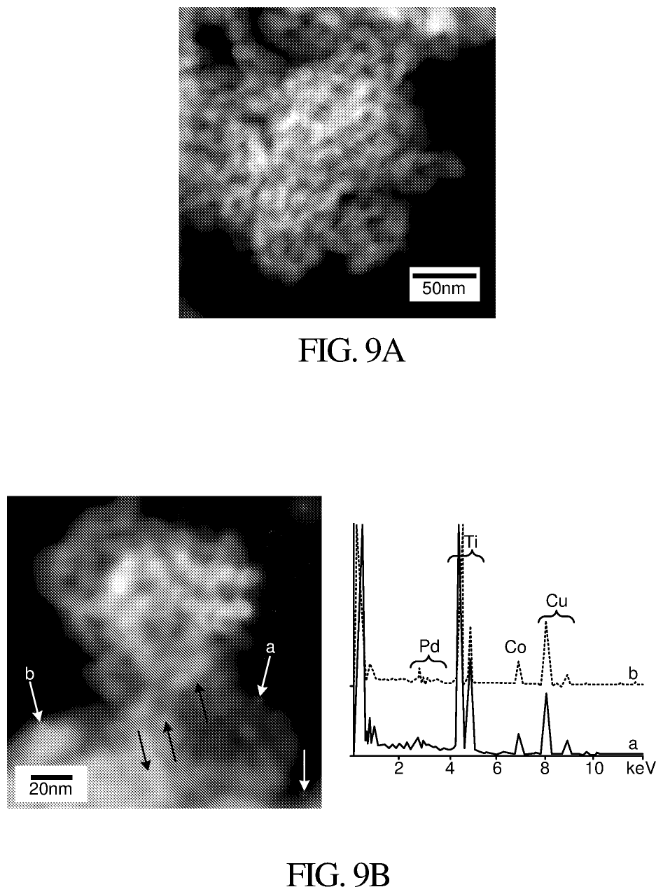

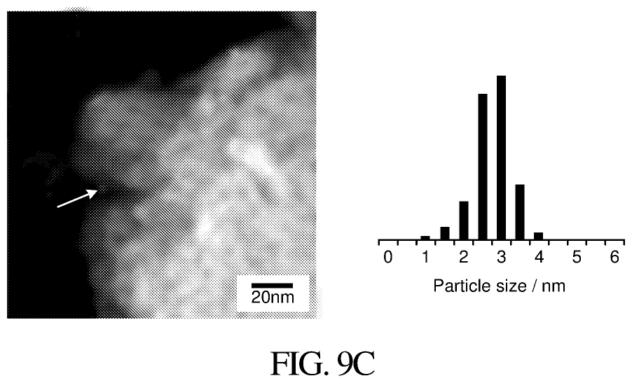

FIG. 9A shows a representative general image of the sample, which is constituted by TiO₂ particles very homogeneous in size. At high magnification (FIG. 9B), individual nanoparticles are recognized well dispersed over the titania support (some of them are marked by arrows in FIG. 9B). Analysis by energy dispersive X-ray spectroscopy (EDS) on individual nanoparticles shows the existence of both cobalt and palladium. As representative examples, the EDS spectra of two nanoparticles (marked as “a” and “b” in FIG. 9B) are included, both showing the common occurrence of Co and Pd and being Co more abundant than Pd according to the composition of the sample. This result indicate that regions of TiO₂ contain CoO, other regions may contain Pd/CoO—TiO₂ where Pd is alone or in an alloy form with a fraction of Co (originating from CoO). It is important to add that the EDS analysis of the titania support did not show the appearance of either cobalt or palladium. FIG. 9C shows another representative image of the sample together with the nanoparticles size distribution histogram obtained using more than one hundred nanoparticles. The mean particle size is centered at 2.8 nm, and the particles had a substantially homogenous particle size.

In summary, nano-composite photocatalysts by impregnating anatase TiO₂ with different amounts of Co salt solutions was prepared, characterized and tested. The presence of CoO enhances the activity of TiO₂ with optimal loading determined to be ca. 2.0 wt. %, and the average rate of hydrogen evolution was about 5 times higher than that of TiO₂ alone. The increasing activity was not due to increasing absorption of the visible light but most likely due to the role of CoO nanoparticles as hole scavengers at the interface with TiO₂. The addition of Pd (as hydrogen ion reduction sites) further improved the reaction rate about 4 times compared to that of the composite system, to 180 μmolg⁻¹min⁻¹. A fraction of Pd appeared to be in the form of Pd—Co alloy dispersed on the CoO/TiO₂ semiconductor support. No catalytic deactivation was seen for prolonged reaction time (up to about 24 hours).

1. A water-splitting photocatalyst comprising photoactive titanium dioxide loaded with 0.5 wt. % to 4 wt. % of a hole-scavenging material comprising cobalt oxide and 0.1 wt. % to 1 wt. % of palladium (Pd).

2. The water-splitting photocatalyst of claim 1, comprising 1.5 wt. % to 2.5 wt. % cobalt oxide and 0.2 wt. % to 0.4 wt. % Pd.

3. The water-splitting photocatalyst of claim 2, comprising about 2 wt. % cobalt oxide and about 0.3 wt. % Pd.

4. The water-splitting photocatalyst of claim 1, wherein the cobalt oxide is cobalt (II) oxide, cobalt (III) oxide, or cobalt (II, III) oxide.

5. The water-splitting photocatalyst of claim 4, wherein the cobalt oxide is cobalt (II) oxide.

6. The water-splitting photocatalyst of claim 1, further comprising a palladium-cobalt alloy.

7. The water-splitting photocatalyst of claim 1, wherein the titanium dioxide is anatase, rutile, or brookite, or any combination thereof.

8. The water-splitting photocatalyst of claim 7, wherein the titanium dioxide is anatase.

9. The water-splitting photocatalyst of claim 7, wherein the titanium dioxide is a mixed-phase comprising anatase and rutile.

10. The water-splitting photocatalyst of claim 9, wherein the weight ratio of anatase to rutile is 1.5:1 to 10:1.

11. The water-splitting photocatalyst of claim 1, wherein photoactive titanium dioxide, the hole-scavenging material, and the Pd are each in particulate form.

12. The water-splitting photocatalyst of claim 11, further comprising a palladium (Pd)-cobalt (Co) alloy that is in particulate form.

13. The water-splitting photocatalyst of claim 12, wherein the photoactive titanium dioxide, the hole-scavenging material, the Pd, and the Pd—Co alloy are each nanostructures or sub-nanostructures, said nanostructure or subnanostructures having at least one dimension equal to or less than 1000 nm.

14. The water-splitting photocatalyst of claim 13, wherein the nanostructures are nanowires, nanoparticles, nanoclusters, or nanocrystals, or combinations thereof.

15. The water-splitting photocatalyst of claim 1, wherein the hole-scavenging material is deposited on the surface of the photoactive titanium dioxide.

16. The water-splitting photocatalyst of claim 15, wherein the Pd is deposited on the surface of the photoactive titanium dioxide or the surface of the hole-scavenging material, or both surfaces.

17. The water-splitting photocatalyst of claim 7, wherein the titanium dioxide is anatase and brookite.

18. An aqueous composition comprising the water-splitting photocatalyst of claim 1.

19. The aqueous composition of claim 18, wherein the aqueous composition has a pH of 7 to 13

20. A method for producing oxygen (O₂) and hydrogen (H₂) from water, the method comprising:
obtaining the aqueous composition of claim 18; and
subjecting the aqueous composition to a light source for a sufficient period of time to produce O₂ and H₂ from the water.
